(19) United States
(12) Patent Application Publication
(10) Pub. No.: US 2024/0396423 A1
(43) Pub. Date: Nov. 28, 2024

(54) PHASE SHIFT SCHEME TO OPTIMIZE THERMAL EFFICIENCY FOR FULL-BRIDGE CONVERTER

(71) Applicant: Advanced Energy Industries, Inc., Denver, CO (US)

(72) Inventor: Anindya Chitta Bagchi, Colma, CA (US)

(21) Appl. No.: 18/323,730

(22) Filed: May 25, 2023

(51) Int. Cl. H02M 1/00; H02M 7/5387

(52) U.S. Cl. CPC H02M 1/0043; H02M 1/0058; H02M 7/53871

(57) ABSTRACT

A power converter may include a first leg comprising a first and a second switch connected to a first terminal of the load, a second leg comprising a third and a fourth switch connected to a second terminal of the load, and a controller configured to regulate switching of the first, second, third, and fourth switches, by switching the switches of each of the first and the second leg in a complementary manner. The controller causes the first leg to be a leading leg for one or more first switching transitions of the switches in the first leg and causes the second leg to be a leading leg for one or more second switching transitions of the switches in the second leg, based at least in part on controlling a phase shift angle for a voltage between the first and the second terminal.

### FIELD OF THE DISCLOSURE

The present disclosure relates generally to full-bridge converters. In particular, but not by way of limitation, the present disclosure relates to systems, methods and apparatuses for a phase shift scheme to optimize thermal efficiency for full-bridge converters.

### DESCRIPTION OF RELATED ART

Full-bridge converters (e.g., DC-DC converters, inverters) are widely used for high-power DC-DC or DC-AC power conversion. The output voltage of such a converter can be controlled by controlling the switches of the full-bridge. Thus, controlling the switches also allows control of the power delivered to a load (e.g., electrosurgical cutting tool) by the converter. Various control schemes exist to control the switches in a full-bridge inverter, and thereby the output voltage and/or power. For instance, one control scheme involves controlling a phase shift between the two terminals coupled to the load, where each terminal corresponds to the connection point between two adjacent switches of a leg of the full-bridge. Another control scheme involves controlling a duty ratio. Yet another control scheme involves controlling the switching frequency.

In some instances, full-bridge inverters may be controlled using a phase shift control scheme, which not only allows for simpler gate driver design, but also zero voltage switching (ZVS) for resonant converters, e.g., without having to vary the tuning frequency. That is, a phase shift full-bridge (PSFB) inverter can be utilized in fixed frequency ZVS converters and/or resonant converters for enhanced reliability.

In some instances, high-power and/or high-frequency AC inverters are used to power electrosurgery. Electrosurgery employs high-frequency current, ranging from hundreds of kHz to several MHz, passed through human tissues to generate desired clinical effects, such as pure cutting, blend cutting and coagulation (COAG).

Currently used high-power and/or high-frequency AC inverters are lacking in several regards, most notably, they tend to be larger than desired and dissipate excessive heat due to switching losses.

The description provided in the Description of Related Art section should not be assumed to be prior art merely because it is mentioned in or associated with this section. The Description of Related Art section may include information that describes one or more aspects of the subject technology.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In some aspects, the techniques described herein relate to a power converter configured to couple to a load, the power converter including: a first leg including a first switch and a second switch, the first and second switches configured to be connected to a first terminal of the load, a second leg including a third switch and a fourth switch, the third and fourth switches configured to be connected to a second terminal of the load; and a controller configured to: regulate switching of the first, second, third, and fourth switches, wherein the switches of each of the first leg and the second leg are turned ON and turned OFF in a complementary manner; cause the first leg to be a leading leg for one or more first switching transitions of the switches in the first leg, based at least in part on controlling a phase shift angle between the first terminal and the second terminal; and cause the second leg to be a leading leg for one or more second switching transitions of the switches in the second leg, based at least in part on controlling the phase shift angle.

In some aspects, the techniques described herein relate to a power converter, wherein the controller is further configured to: cause the first leg to be a lagging leg for one or more third switching transitions of the switches in the first leg; and cause the second leg to be the lagging leg for one or more fourth switching transitions of the switches in the second leg

In some aspects, the techniques described herein relate to a power converter, wherein: the first leg is the leading leg and the second leg is the lagging leg for a first period, the first period including the one or more first switching transitions and the one or more fourth switching transitions; the second leg is the leading leg and the first leg is the lagging leg for a second period, the second period including the one or more second switching transitions and the one or more third switching transitions; and a duration of the first period is substantially equal to the second period.

In some aspects, the techniques described herein relate to a power converter, wherein: the phase shift angle is at or above 0 degrees during the first period; and the phase shift angle is below 0 degrees during the second period.

In some aspects, the techniques described herein relate to a power converter, wherein: a first voltage at the first terminal leads a second voltage at the second terminal when the first leg is the leading leg, and the second voltage leads the first voltage when the second leg is the leading leg.

In some aspects, the techniques described herein relate to a power converter, wherein a voltage between the first terminal and the second terminal is out of phase by 180 degrees during the first period as compared to the second period.

In some aspects, the techniques described herein relate to a power converter, wherein switching losses associated with a leading leg are substantially evenly distributed between the first leg and the second leg.

In some aspects, the techniques described herein relate to a power converter, wherein, when the first leg is the leading leg, the first switch and the second switch are regulated using first and second PWM signals, respectively, and wherein the first and second PWM signals have a constant or substantially constant duty ratio; and the third switch and the fourth switch are regulated using third and fourth PWM signals, respectively, and wherein the third and fourth PWM signals have a variable duty ratio.

In some aspects, the techniques described herein relate to a power converter, wherein the phase shift angle and a voltage between the first terminal and the second terminal are based at least in part on the first, second, third, and fourth PWM signals.

In some aspects, the techniques described herein relate to a power converter, wherein, when the second leg is the leading leg and the first leg is the lagging leg, the first switch and the second switch are regulated using first and second PWM signals, respectively, and wherein the first and second PWM signals have a variable duty ratio; and the third switch and the fourth switch are regulated using third and fourth PWM signals, respectively, and wherein the third and fourth PWM signals have a substantially constant duty ratio.

In some aspects, the techniques described herein relate to a power converter, wherein the phase shift angle and a voltage between the first terminal and the second terminal are based at least in part on the first, second, third, and fourth PWM signals.

In some cases, causing the first leg to be the leading leg for the one or more switching transitions of the switches in the first leg is based at least in part on controlling the phase shift angle for the voltage (e.g., voltage V_{AB} in the following figures) between the first terminal (e.g., terminal A) and the second terminal of the first leg and the second leg, respectively.

In some cases, causing the second leg to be the leading leg for the one or more switching transitions of the switches in the second leg is based at least in part on controlling the phase shift angle for the voltage (e.g., voltage V_{AB} in the following figures) between the first terminal (e.g., terminal A) and the second terminal of the first leg and the second leg, respectively.

In some aspects, the techniques described herein relate to a power converter, wherein each of the one or more first, second, third, and fourth switching transitions includes one of: a passive to active transition when, prior to a corresponding one of the first, second, third, or fourth switching transitions, a voltage between the first terminal and the second terminal is at or near zero volts, or an active to passive transition when, prior to a corresponding one of the first, second, third, or fourth switching transitions, an initial voltage is non-zero volts.

In some aspects, the techniques described herein relate to a power converter, wherein: zero voltage switching (ZVS) is achieved in a corresponding leg during active to passive transitions; and non-zero voltage switching or low voltage switching is achieved in a corresponding leg during passive to active transitions and when the phase shift angle is at or below a threshold.

In some aspects, the techniques described herein relate to a power converter, wherein the power converter includes a phase-shift full-bridge (PSFB) inverter.

In some aspects, the techniques described herein relate to a method for phase shift control, the method including: providing a full bridge power converter, wherein the full bridge power converter is configured to couple to a load and includes, a first leg including a first switch and a second switch, the first and second switches configured to be connected to a first terminal of the load, and a second leg including a third switch and a fourth switch, the third and fourth switches configured to be connected to a second terminal of the load; and the method further including: regulating switching of the first, second, third, and fourth switches, wherein the switches of each of the first leg are turned ON and turned OFF in a complementary manner; and controlling a phase shift angle between the first terminal and the second terminal such that, the first leg is a leading leg for one or more first switching transitions of the switches in the first leg, and the second leg is a leading leg for one or more second switching transitions of the switches in the second leg.

In some aspects of the method, the phase shift angle (e.g., a phase shift angle for a voltage, V_{AB}, between the first terminal and the second terminal) is based at least in part on at least one switch of the first leg turning ON or OFF at a different time than at least one switch of the second leg.

In some aspects of the method, causing the first leg to be the leading leg for the one or more switching transitions of the switches in the first leg is based at least in part on controlling the phase shift angle for the voltage (e.g., voltage V_{AB} in the following figures) between the first terminal (e.g., terminal A) and the second terminal of the first leg and the second leg, respectively.

In some aspects of the method, causing the second leg to be the leading leg for the one or more switching transitions of the switches in the second leg is based at least in part on controlling the phase shift angle for the voltage (e.g., voltage V_{AB} in the following figures) between the first terminal (e.g., terminal A) and the second terminal of the first leg and the second leg, respectively.

In some aspects, the techniques described herein relate to a method, further including causing the first leg to be a lagging leg for one or more third switching transitions of the switches in the first leg; and causing the second leg to be the lagging leg for one or more fourth switching transitions of the switches in the second leg.

In some aspects, the techniques described herein relate to a method, wherein: the first leg is the leading leg and the second leg is the lagging leg for a first period, the first period including the one or more first switching transitions and the one or more fourth switching transitions; the second leg is the leading leg and the first leg is lagging leg for a second period, the second period including the one or more second switching transitions and the one or more third switching transitions; and a duration of the first period is substantially equal to the second period.

In some aspects, the techniques described herein relate to a method, wherein: the phase shift angle is at or above 0 degrees during the first period; and the phase shift angle is below 0 degrees during the second period.

In some aspects, the techniques described herein relate to a method, wherein switching losses associated with a leading leg are substantially evenly distributed between the first leg and the second leg.

In some aspects, the techniques described herein relate to a non-transitory, tangible computer readable storage medium, encoded with processor readable instructions to perform a method for phase shift control of a power converter, wherein the power converter is configured to couple to a load and includes a first leg and a second leg, the method further including: connecting a first terminal of the load between a first switch and a second switch of the first leg; connecting a second terminal of the load between a third switch and a fourth switch of the second leg; regulating switching of the first, second, third, and fourth switches of the power converter, wherein the switches of each of the first leg and the second leg are turned ON and turned OFF in a complementary manner; and controlling a phase shift angle between the first terminal and the second terminal such that, the first leg is a leading leg for one or more first switching transitions of the switches in the first leg, and the second leg is a leading leg for one or more second switching transitions of the switches in the second leg.

In some aspects of the non-transitory, tangible computer readable storage medium, the phase shift angle is based at least in part on at least one switch of the first leg turning ON or OFF at a different time than at least one switch of the second leg.

In some aspects of the non-transitory, tangible computer readable storage medium, causing the first leg to be the leading leg for the one or more switching transitions of the switches in the first leg is based at least in part on controlling the phase shift angle for the voltage (e.g., voltage V_{AB} in the following figures) between the first terminal (e.g., terminal A) and the second terminal of the first leg and the second leg, respectively.

In some aspects of the non-transitory, tangible computer readable storage medium, causing the second leg to be the leading leg for the one or more switching transitions of the switches in the second leg is based at least in part on controlling the phase shift angle for the voltage (e.g., voltage V_{AB} in the following figures) between the first terminal (e.g., terminal A) and the second terminal of the first leg and the second leg, respectively.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1A illustrates an example of a power converter controlled using a phase shift scheme, according to various aspects of the disclosure.

FIG. 1B illustrates an example of a power converter having a phase-shift full-bridge (PSFB) inverter, according to various aspects of the disclosure.

FIG. 2A illustrates a timing diagram showing waveforms for a PSFB inverter for a first phase shift angle, as seen in the prior art.

FIG. 2B illustrates another timing diagram showing waveforms for a PSFB inverter for a second phase shift angle, where the second phase shift angle is lower than the first phase shift angle in FIG. 2A, as seen in the prior art.

FIG. 3A illustrates an example of a timing diagram showing waveforms for the PSFB inverter in FIGS. 1A and/or 1B, according to various aspects of the disclosure.

FIG. 3B illustrates another example of a timing diagram showing waveforms for the PSFB inverter in FIGS. 1A and/or B, according to various aspects of the disclosure.

FIG. 3C illustrates another example of a timing diagram showing waveforms for the PSFB inverter in FIGS. 1A and/or 1B, according to various aspects of the disclosure.

FIG. 3D illustrates an example of a voltage output waveform corresponding to the waveforms depicted in FIG. 3A, according to various aspects of the disclosure.

FIG. 3E illustrates an example of a voltage output waveform corresponding to the waveforms depicted in FIG. 3C, according to various aspects of the disclosure.

FIG. 4 illustrates an example of a method directed to a phase shift control scheme for full-bridge converters to assist in thermal management, according to various aspects of the disclosure.

FIG. 5 illustrates another example of a method directed to a phase shift control scheme for full-bridge converters to assist in thermal management, according to various aspects of the disclosure.

FIG. 6 illustrates a block diagram of a computer system that may be used to implement one or more aspects of the present disclosure.

### DETAILED DESCRIPTION

The present disclosure relates generally to generally to full-bridge converters. In particular, but not by way of limitation. More specifically, but without limitation, the present disclosure relates to systems, methods and apparatuses for a phase shift scheme to optimize thermal efficiency for full-bridge converters.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Full-bridge inverters are widely used for high-power DC-DC or DC-AC power conversion. Rather than hard switching the switches (e.g., power MOSFETs) like a conventional full bridge or forward converter, phase-shifted full-bridge (PSFB) converters are operated by clamping and recycling the stored switching energy to softly turn on each of the switches (e.g., four power MOSFETs) in the full bridge. In some instances, zero voltage switching (ZVS) occurs when the switches are turned ON and OFF when the voltage across the switch (e.g., their respective drain to source voltages (V_{DS})) are at or near zero volts, which effectively eliminates the instantaneous turn on-power loss of the switches (e.g., caused by the drain-to-source capacitance (C_{OSS}) and/or parasitic capacitance discharge). In this way, PSFB converters can help enhance efficiency, reduce switching related electromagnetic interference (EMI), and/or reduce the need for primary-side snubbers.

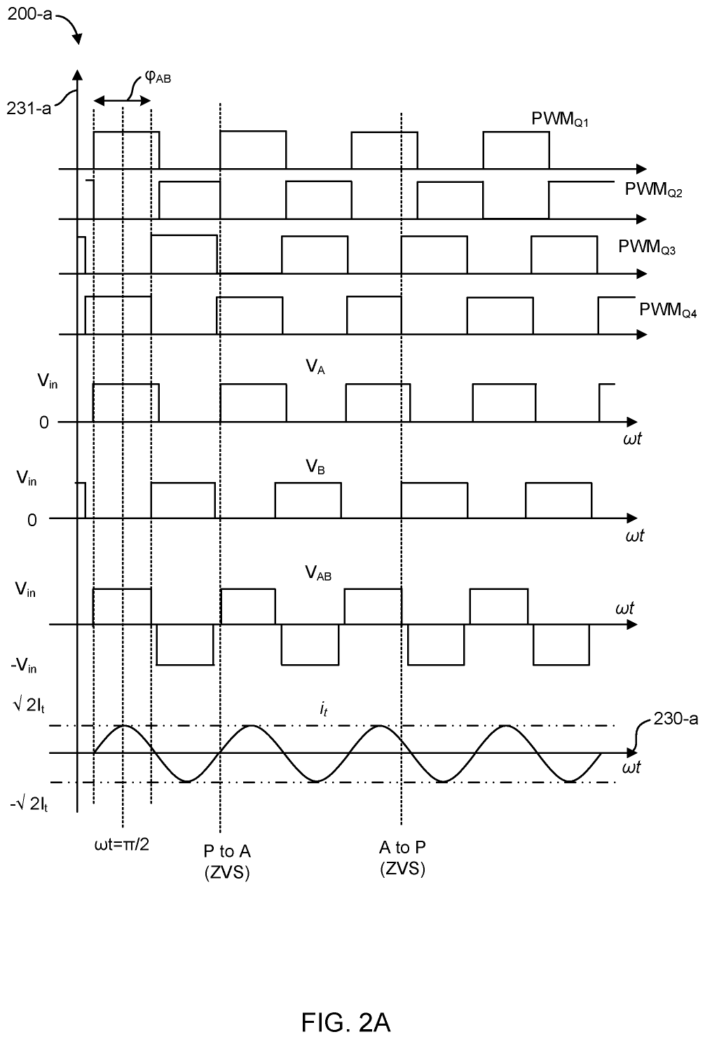

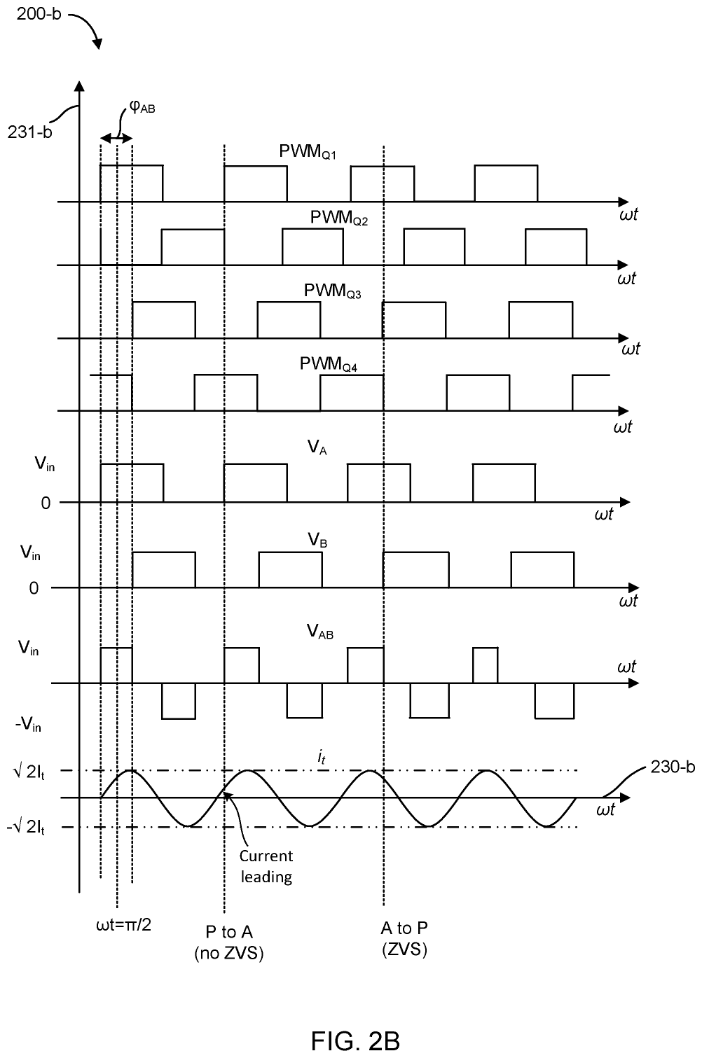

In some circumstances, however, existing control schemes (e.g., phase shift control) for regulating the switches of full-bridge inverters are lacking. For example, when PSFB inverters are employed in instances where a wide operating range (e.g., amplitude and/or phase shift of output voltage) is required, they often need extensive modifications, which adds to the cost, complexity, bulk, etc., of the overall system. Additionally, or alternatively, a wide operating range for PSFB inverters may cause large changes in the phase shift angle (e.g., from 0 to 180 degrees) during operation, which in turn may lead to hard-switching losses in the leading leg of the PSFB inverter. For instance, the drain to source voltage (V_{DS}) of one or more switches in the leading leg may not be at or near zero volts at the instant they are turned ON or OFF. In other words, the leading leg may encounter losses due to the lack of ZVS, as further described in relation to FIGS. 2A-2B. In some cases, the phase shift angle (φ_{AB}) for the voltage between the terminals coupled to the load may dictate whether the switching devices in the leading leg switch with ZVS for at least some switching transitions. For example, when the phase shift angle (φ_{AB}) is high (e.g., at least 120 degrees, at least 150 degrees, at or near 180 degrees, to name three non-limiting examples), there is a higher likelihood of ZVS conditions in the leading leg for most, if not all, switching transitions. However, when the phase shift angle (φ_{AB}) is low (e.g., below 120 degrees, below 90 degrees, at or near 0 degrees), ZVS may not be achieved for all switching transitions. Efficiency aside, hard-switching losses lead to heat dissipation in the switches. To prevent damage to the various components (e.g., switches) of the PSFB inverter, heat sinks and other thermal management components are utilized to remove the heat to the external environment.

To address these efficiency and thermal issues, some prior art techniques utilize soft-switch assistance or zero voltage switching (ZVS) assistance circuits. However, the addition of ZVS assistance circuits leads to additional hardware complexity and design challenges. Additionally, or alternatively, some prior art systems utilize a current boost (i.e., inject current) to force ZVS during low phase shift angles, which helps reduce heat dissipation losses. However, current injection techniques are often limited to scenarios where the output voltage varies slowly (e.g., on the order of hundreds of milliseconds or longer). Additionally, or alternatively, the prior art current injection techniques are limited to narrower operating phase shift ranges (e.g., operating phase shift range is <30degrees or <45 degrees, to name two non-limiting examples) and systems with slower dynamics. In some cases, complex multiple-phase-angle control schemes may need to be employed to achieve faster dynamic operation, which may be cost prohibitive, difficult to implement, etc., in certain scenarios. In some circumstances, a PSFB inverter may be utilized in situations where large variations in output voltage and/or phase shift, as well as a wide operating range may be needed. Furthermore, the PSFB inverter may need to be compact enough to allow it to be incorporated in a volume constrained system, such as, but not limited to, an electrosurgical system.

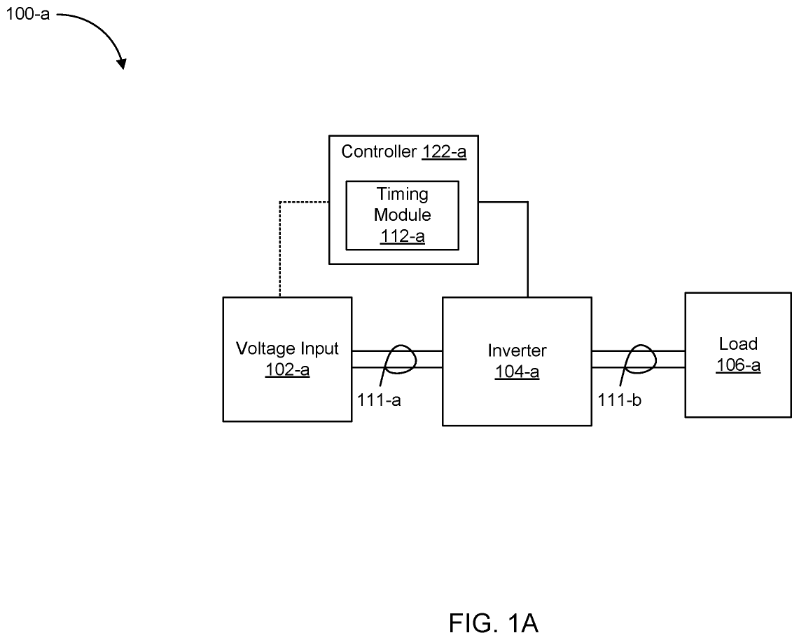

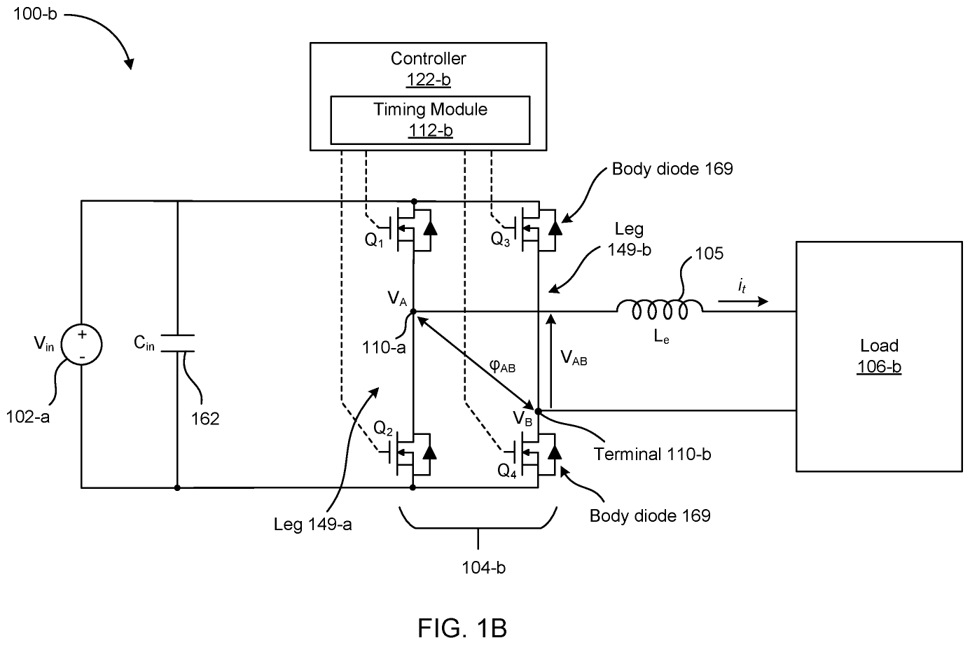

Thus, there is a need for a refined PSFB inverter that can help alleviate some of the issues seen in the prior art. Additionally, or alternatively, there is also a need for a refined phase shift control scheme for an existing PSFB inverter. In the prior art, one of the two legs of the full-bridge is fixed as the “leading leg” and incurs all or a majority of the hard switching losses. For instance, in the prior art, leg 149-a in FIG. 1B may be fixed as the leading leg, while leg 149-b may be fixed as the lagging leg. However, this asymmetric distribution of hard-switching losses across the two legs leads to a more complex and/or bulky thermal management system to ensure the integrity of the switches (e.g., MOSFETs, although other types of switches are also contemplated in different embodiments) in the leading leg.

In accordance with aspects of the present disclosure, heat dissipation losses may be managed more efficiently by alternating between which one of the two legs (e.g., first leg 149-a, second leg 149-b in FIG. 1B) of the PSFB inverter 100-b is the leading leg and which is the lagging leg, further described in relation to the figures below. By alternating which of the two legs of the full-bridge is the leading leg (i.e., incurring more heat dissipation losses due to no ZVS), thermal dissipation can be distributed evenly or substantially evenly across the two legs, which helps in one or more of (1) avoiding soft-switch assistance circuits or ZVS assistance circuits, (2) less complexity compared to combined phase shift and frequency modulation control schemes, (3) a smaller footprint or more compact form factor, (4) smaller and/or simpler heat sink design, and/or (5) reduced conduction losses. In this way, aspects of the present disclosure may enable the PSFB inverter(s) 100-a, 100-b to be implemented in volume constrained systems calling for a wide operating range (e.g., output voltage may vary from +200V down to 0V within 10 ms). One non-limiting example of a volume constrained system in which the disclosed PSFB inverter can be implemented may include an electrosurgical system, described in further detail below. However, it should be noted that, other uses besides electrosurgical systems are contemplated in different embodiments and the examples listed herein are not intended to be limiting.

### Example Use Case

In some instances, high-power and/or high-frequency alternating current (AC) inverters are used to power electrosurgery. Electrosurgery employs high-frequency current, ranging from hundreds of kHz to several MHz, passed through human tissue to generate desired clinical effect(s), such as pure cutting, blend cutting and coagulation (COAG). Power devices, such as the ones described herein, may support high frequency and low switching losses, which can help facilitate enhancements in electrosurgery, amongst other areas.

In one non-limiting example, a PSFB inverter (e.g., PSFB inverter 100-b in FIG. 1B) may be utilized in an electrosurgery system, where the electrosurgery system is configured to output a variable high frequency AC output voltage to a varying load impedance. In some instances, electrosurgery generators (ESG) used to power electrosurgery may comprise a full-bridge converter (e.g., full-bridge inverter comprising two half-bridges) coupled between a power supply (e.g., DC power supply, shown as voltage input 102-a in FIG. 1A) and a load (e.g., shown as load 106-a in FIG. 1A). Further, human tissue to be cut/sliced may be positioned between an electric scalpel and a pad, where the scalpel is coupled to a first terminal (e.g., terminal 110-a in FIG. 1B) of the full-bridge inverter, while the pad is coupled to a second terminal (e.g., terminal 110-b in FIG. 1B) of the full-bridge inverter. In some cases, different output voltage magnitudes may be required for different clinical or surgical purposes. Furthermore, during electrosurgery, the load impedance may vary significantly. For example, different types of human tissue, such as, skin, muscle, fat, etc., may be characterized by different electrical properties, impedance, etc. Furthermore, tissue impedance may also vary for the same tissue based on the speed and/or direction of the electric scalpel. In some circumstances, plasma arcing transients may also cause variations in tissue impedance during electrosurgery.

It should be noted that electrosurgery is merely one non-limiting example of a use case for the phase shift full-bridge inverter described in the present disclosure, and other use cases are contemplated in different embodiments.

Turning now to FIG. 1A, which illustrates a block diagram of an apparatus 100-a, according to various aspects of the disclosure. As seen, the apparatus 100-a comprises a voltage input 102-a (e.g., a DC voltage input), a controller 122-a comprising a timing module 112-a, an inverter 104-a (e.g., a phase shift full-bridge inverter), and a load 106-a. In this example, the PSFB inverter 104-a is coupled between the voltage input 102-a and the load 106-a using electrical connections 111-a and 111-b, respectively.

FIG. 1B illustrates a detailed view of an apparatus 100-b, according to various aspects of the disclosure. The apparatus 100-b may be similar or substantially similar to the apparatus 100-a described in relation to FIG. 1A. Here, the apparatus 100-b comprises a voltage input 102-b (e.g., DC voltage input), an input capacitor (Cᵢₙ) 162, a load 106-b (also referred to as external circuit 106-b), and a full-bridge inverter 104-b coupled between the input voltage 102-b and the load 106-b. The apparatus 100-b also comprises a controller 122-b, where the controller 122-b comprises a timing module 112-b. The controller 122-b (either directly or via the timing module 112-b) is configured to control the switches Q₁ through Q₄. Specifically, the controller 122-b (or the timing module 112-b) controls when each of the switches Q₁ through Q₄ is an ON state or OFF state, which helps control the output voltage (Vₒᵤₜ), current (iₜ), and power delivered to the load 106-b. FIG. 1B also shows a body diode 169 connected between the drain and source of each of the switches Q₁ through Q₄. In one non-limiting example, the switches Q₁ through Q₄ may comprise active switches, such as Metal-Oxide Semiconductor Field Effect Transistors (MOSFETs). However, other types of switches besides MOSFETs are contemplated in different embodiments, and the examples listed herein are not intended to be limiting. Some non-limiting examples of switches that may be utilized in the PSFB converter include Bipolar Junction Transistors (BJTs), Insulated Gate Bipolar Transistors (IGBTs), Gate turn-off Thyristors (GTOs), and MOS-Controlled Thyristors (MCTs). Furthermore, it should be noted that the switches may or may not include a body diode, and the depiction of the body diode 169 in FIG. 1B is exemplary only and should not be construed as limiting the scope or spirit of the present disclosure. In some other cases, one or more of the switches Q₁ through Q₄ may be replaced by switch network (or switching element), where the switching element comprises two or more switches arranged in series or parallel (e.g., to allow lower power devices to be used).

As previously noted, the switches (e.g., switches Q₁, Q₂, Q₃, Q₄) in a full-bridge inverter 104-b are controlled using a variety of control schemes (e.g., controlling a phase shift angle between the terminals 110-a and 110-b, controlling a duty ratio of the pulse width modulation or PWM signals used to drive the switches, controlling a switching frequency of the switches), which allows control of the potential difference or voltage (V_{AB}) between the two terminals 110-a, 110-b, and the current (iₜ) flowing to the load 106-b. In this way, the power delivered to the load 106-b can be controlled by controlling when each of the switches Q₁, Q₂, Q₃, and Q₄ is an ON state or an OFF state.

In some embodiments, the full-bridge inverter 104-b in FIG. 1B may be controlled using a phase shift control scheme, which facilitates simpler gate driver design and/or ZVS (i.e., without having to vary the tuning frequency).

As seen, the PSFB inverter 104-b comprises two half bridges (or legs) of switches, where a first leg 149-a comprises switches Q₁ and Q₂ arranged in series and a second leg 149-b comprises switches Q₃ and Q₄ arranged in series. The terminal 110-a corresponds to a connection point between the series arranged switches Q₁ and Q₂ and the terminal 110-b corresponds to a connection point between the series arranged switches Q₃ and Q₄. As seen, the terminal 110-a is coupled to a first end of an inductor 105 (Lₑ) and a second end of the inductor 105 is coupled to one end of the load 106-b. Additionally, a second, opposing end of the load 106-b is coupled to the terminal 110-b to complete the return connection.

In some cases, the switches in each leg (or half-bridge) are driven with complementary pulse width modulated (PWM) signals. A duty ratio and/or frequency of the PWM signals used to drive the switches may be based at least in part on the desired waveform (e.g., magnitude and/or frequency of the output voltage, Vₒᵤₜ) provided to the load 106-b. In some cases, the controller 122-b is configured to drive and control the phase shift of PWM signals driving switches Q₁, Q₂ in leg 149-a of the full-bridge with respect to the PWM signals driving switches Q₃, Q₄ in the other leg 149-b. In some examples, the switches of each leg are switched in a complementary manner for phase shift control of the PSFB inverter 104-b. For example, when switch Q₁ is ON, switch Q₂ is OFF and vice-versa, and similarly, when switch Q₃ is ON, switch Q₄ is OFF and vice versa. However, Q₁ and Q₄ and Q₂ and Q₃ may not switch in a complementary fashion—there may be overlap between the switches of the legs, where greater overlap equates to a smaller phase shift angle (φ_{AB}) between the legs, and larger delivered power. Said another way, in some instances, when power is being delivered to the load 106-b, two diagonal switches (e.g., switches Q₁ and Q₄) of the left and right legs 149-a and 149-b, respectively, may be in an ON state and the other two diagonal switches (e.g., switches Q₂ and Q₃) may be in an OFF state. In some embodiments, the phase shift angle (φ_{AB}) dictates the amount of overlap between two diagonally opposite switches (e.g., switches Q₁ and Q₄). The longer the overlap between diagonal switches, the larger the amount of energy delivered to the load 106-b. In this way, by controlling the phase shift between the PWM signals driving the switches in the two legs 149-a, 149-b, the controller 122-b regulates the voltage output (Vₒᵤₜ or V_{AB}) and power transfer to the load 106-b.

As used herein, the term “switching transition” refers to an event where any of the switches that are in an ON state are turned OFF or any of the switches that are in the OFF state are turned ON. As an example, a switching transition may comprise switching two diagonal switches (e.g., switches Q₁, Q₄) that are in an ON state to an OFF state or vice-versa. Similarly, a switching transition may comprise switching the other two diagonal switches (e.g., switches Q₂, Q₃) from an OFF state to an ON state or vice-versa. To reduce or minimize switching losses, ideally, the voltage across the switches should be at or near zero volts during a turn-on switching transition, which is also referred to as zero voltage switching or ZVS; or the current through the switches should be at or near zero amps during a turn-off switching transition, which is also referred to as zero current switching or ZCS. In some circumstances, the voltage across a switch or current through a switch may have a non-zero value during a switching transition, which can lead to switching losses in the corresponding leg. Primarily, for Metal-Oxide Semiconductor Field Effect Transistor (MOSFET) and/or Insulated-Gate Bipolar Transistor (IGBT) based systems typically employed for PSFB based systems, ZVS may be preferred as the losses due to the energy stored in their parasitic capacitances are more dominant contributors to switching losses in them.

As used herein, the terms “passive to active transition” or “P to A transition” refers to a switching transition that causes the voltage (V_{AB}) to go from an initial voltage of 0 volts to a non-zero voltage (i.e., positive or negative non-zero voltage). Similarly, the terms “active to passive transition” or “A to P transition” refers to a switching transition that causes the voltage (V_{AB}) to go from an initial non-zero voltage (i.e., positive or negative non-zero voltage) to a zero voltage.

Typically, in prior art systems, one leg (e.g., left leg or leg 149-a) of the PSFB inverter is fixed as the leading leg, while the other leg (e.g., right leg or leg 149-b) is fixed as the lagging leg. In some circumstances, however, a majority or all of the hard-switching losses are seen in the leading leg as a result of non-ZVS conditions during certain transitions (e.g., passive to active transition, also referred to as P-A transition). On the other hand, losses are kept to a minimum in the lagging leg, since ZVS is achieved for all or a majority of switching transitions in the lagging leg. This asymmetric distribution of losses between the two legs often necessitates a more complex heat sink design. Additionally, or alternatively, soft-switching assistance circuits or ZVS assistance circuits are employed to force ZVS in both the leading and the lagging legs, which adds hardware complexity and/or design challenges to the overall system.

In some instances, if the phase shift angle (φ_{AB}) corresponding to the voltage (V_{AB}) between the two terminals 110-a and 110-b is “high”, for instance, above a certain threshold (e.g., above 90 degrees, above 120 degrees, etc.), then both the left leg and right leg switching transitions achieve (or result in) ZVS, as depicted in FIG. 2A. However, when the phase shift angle (φ_{AB}) is “low”, for instance, below a certain threshold (e.g., below 90 degrees, below 60 degrees, etc.), then no ZVS (or less ZVS, also referred to as low voltage switching or LVS) is encountered as a result of the left leg switching transition, since the left leg is the leading leg. It should be noted that, and as depicted in FIGS. 2A-B, ZVS may be achieved for all switching transitions in the right leg since the right leg is the lagging leg.

FIG. 2A depicts examples of waveforms 200-a for a prior art PSFB inverter during a high phase shift angle (e.g., φ_{AB}˜180 degrees). FIG. 2A also depicts the pulse width modulation (PWM) waveforms used to drive each of switches Q₁, Q₂, Q₃, and Q₄ in FIG. 1B. Furthermore, FIG. 2A also depicts the V_{A} and V_{B} waveforms at the terminals 110-a and 110-b, respectively, in FIG. 1B. The waveform V_{AB} corresponding to the voltage between the two terminals 110-a and 110-b is derived from a difference between waveforms V_{A} and V_{B}. Lastly, FIG. 2A also shows the waveform for the current (iₜ) flowing to the load (e.g., load 106-b in FIG. 1B). In the example shown, the vertical or y-axis 231-a shows the magnitude of the voltages V_{A}, V_{B}, and V_{AB}, as well as the magnitude of the current (iₜ) flowing towards the load. Additionally, time is shown along the horizontal or x-axis 230-a.

As seen, the PWM waveforms used to drive switch Q₁ and Q₂ in the leg 149-a are complementary to each other, and the PWM waveforms used to drive switch Q₃ and Q₄ in the leg 149-a are also complementary to each other. In this example, switch Q₁ and Q₄ are turned ON and/or OFF at slightly different times (180 degrees−φ_{AB}), as seen by the rising and falling edges of their respective PWM pulses. For instance, the rising and falling edges of PWM_{Q1} are shifted in time relative to the rising and falling edges, respectively, of PWM_{Q4}. Similarly, the rising and falling edges of PWM_{Q2} and PWM_{Q3} are also shifted in time. That is, the rising and falling edges of PWM_{Q2} do not coincide with the rising and falling edges, respectively, of PWM_{Q3}. FIG. 2A illustrates this phase shift angle (φ_{AB}) between the PWM signal pairs PWM_{Q1}-PWM_{Q3} and PWM_{Q2}-PWM_{Q4}. The voltage pulses V_{A} and V_{B} are expected to also be phase shifted by the phase shift angle (φ_{AB}), as depicted in FIG. 2A.

As noted above, the voltage pulse V_{AB} corresponds to the difference between the voltages V_{A} and V_{B}. Furthermore, a A-P transition refers to a switching transition that causes the voltage V_{AB} to go from a non-zero voltage to 0 volts, while a P-A transition refers to a switching transition that causes the voltage V_{AB} to go from 0 volts to a non-zero voltage. In some cases, ZVS may or may not be achieved depending on the polarity and/or magnitude of the tank current (iₜ) at the instant a respective switch turns ON. In some instances, ZVS is achieved when prior to turn-on of a switch, the current through that switch is sufficiently negative to discharge the energy across its drain-to-source capacitance (C_{ds}). In some cases, such as for PSFB converters, ZVS may be achieved when (1) tank current (iₜ) is sufficiently negative for turning on switches Q₁ and/or Q₄; and/or the tank current (iₜ) is sufficiently positive for turning on switches Q₂ and/or Q₃. In the example shown in FIG. 2A, both the P-A transition (i.e., left leg transition) and A-P transition (i.e., right leg transition) achieve or result in ZVS, which facilitates lossless switching. For instance, with reference to FIGS. 2A-B, the conditions (1) and/or (2) listed above are satisfied in the P-A transitions in FIG. 2A, as well as in the A-P transitions in both FIGS. 2A and 2B. That is, the switches achieve ZVS in both the A-P and P-A transitions in FIG. 2A, and in the A-P transitions in FIG. 2B. However, in the P-A transitions in FIG. 2B, a sufficiently positive tank current flows through switch Q₁ prior to or during turn on, and a sufficiently negative tank current flows through Q₂ at the instant it is turned on, which results in no ZVS conditions for the P-A transitions in FIG. 2B. In other words, the switches Q₁ and Q₂ of the leading leg in FIG. 2B do not achieve ZVS.

FIG. 2B depicts examples of waveforms 200-b for a prior art PSFB inverter during a low phase shift angle (e.g., φ_{AB} is below a threshold, where the threshold may be 120 degrees, 90 degrees, 60 degrees, to name a few). Low phase angle is associated with lower outputs, while higher phase angle is associated with higher outputs. In the example shown, the vertical or y-axis 231-b shows the magnitude of the voltages V_{A}, V_{B}, and V_{AB}, as well as the magnitude of the current (iₜ) flowing towards the load. Additionally, time is shown along the horizontal or x-axis 230-b. In this example, the phase shift angle (φ_{AB}) between the PWM signal pairs PWM_{Q1}-PWM_{Q3} and/or the PWM_{Q2}-PWM_{Q4} is lower than the phase shift angle (φ_{AB}) seen in FIG. 2A. As a result, the phase shift angle (φ_{AB}) between the voltages V_{A} and V_{B} is also lower.

In this instance, while the A-P transition in the right leg achieves ZVS (i.e., since the current through Q₃ and Q₄ have negative values at the instant switches Q₃ and Q₄ change state), the P-A transition does not, as a result of the current (iₜ) leading with respect to the switching instant in the P-A transition. In other words, during the P-A switching transition(s) (i.e., when one of the switches Q₁ or Q₂ turns ON), the current through a respective one of Q₁ and Q₂ has a positive value, which result in no ZVS (or less ZVS) conditions. Thus, when the phase shift angle (φ_{AB}) is low (i.e., below a threshold, such as 120 degrees), ZVS is not seen for at least a portion of the switching transitions, for instance, P to A transitions in the leading leg. Typically, phase-shift controlled power electronics systems target a high phase shift angle (φ_{AB}) control range, e.g., from around 150-180 degrees, to prevent or reduce the likelihood of no ZVS conditions during switching transitions. However, some use cases, for instance, in medical systems where a RF output waveform having wide amplitude variations (e.g., in a power range of up to 500 W) is desired, a wide range of phase shift angles (φ_{AB}) is desired to control the amplitude of the RF output waveform. In such cases, at least a portion of the switching transitions may occur during less ZVS or no ZVS conditions, thereby resulting in switching losses, and those switching losses will pile up on one of the two legs. Additional challenges arise when the phase shift angle (φ_{AB}) varies rapidly (e.g., from about 180 degrees to about 30 degrees within 10 milliseconds) to effectuate a large amplitude variation (e.g., from about 200 V to 0 V in under 10 milliseconds), as further described below.

As previously noted, the left leg (e.g., leg 149-a in FIG. 1B) is the leading leg, while the right leg (e.g., leg 149-b) is the lagging leg in the waveforms discussed in relation to FIGS. 2A-B. In some cases, hard switching losses can increase in the leading leg manifold between operating points for wide range phase shift control applications, where a “wide range” phase shift control application may correspond to a phase shift range of 60-180 degrees, or 30-180 degrees, to name two non-limiting examples. In other words, for applications or use cases where the phase shift angle (φ_{AB}) varies significantly (e.g., between 0 and 180 degrees) in a short duration of time (e.g., on the order of milliseconds), one of the two legs, such as the leading leg, incurs substantial heat dissipation losses as a result of no ZVS during low phase shift angles. As previously noted, large variations in the phase shift angle may be utilized to create RF output waveforms with wide amplitude variations, e.g., +200 V to 0 V in a few milliseconds, −150 V to +100V in a few milliseconds, +500 V to −300 V within 10 milliseconds, to name a few non-limiting examples. In such cases, if all (or most) of the switching losses are experienced in the leading leg, there is little time to effectively dissipate the heat in that leg before the next lossy switching transition. Said another way, when rapid variations in phase shift angles are employed to effectuate rapid variations in the RF output waveform, the switching losses incurred in the leading leg as a result of a first lossy switching transition may not fully dissipate before a second, subsequent lossy switching transition is encountered. As a result, the leading leg may remain at an elevated temperature for significant lengths of time, which can adversely affect performance and/or necessitate a more complex heat sink design.

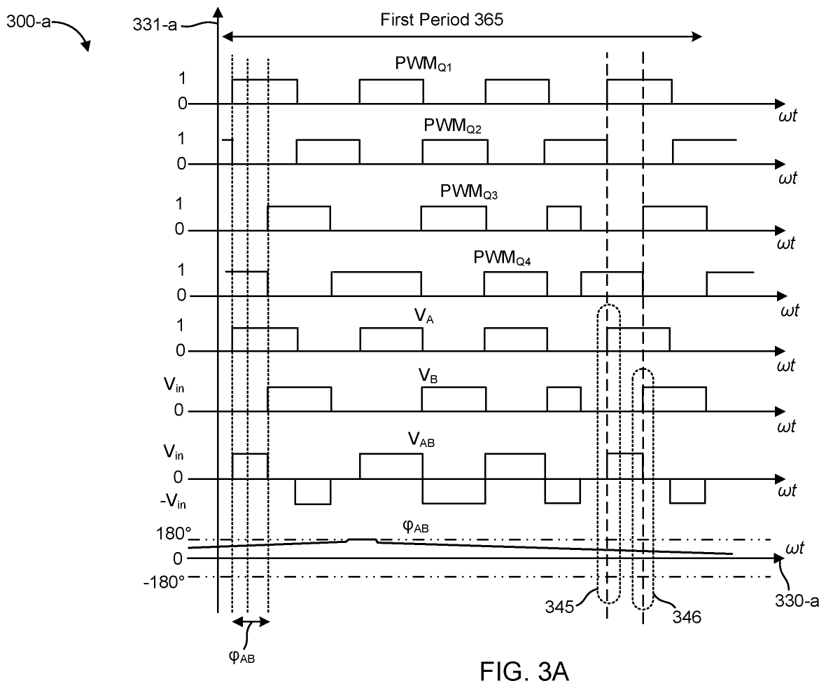

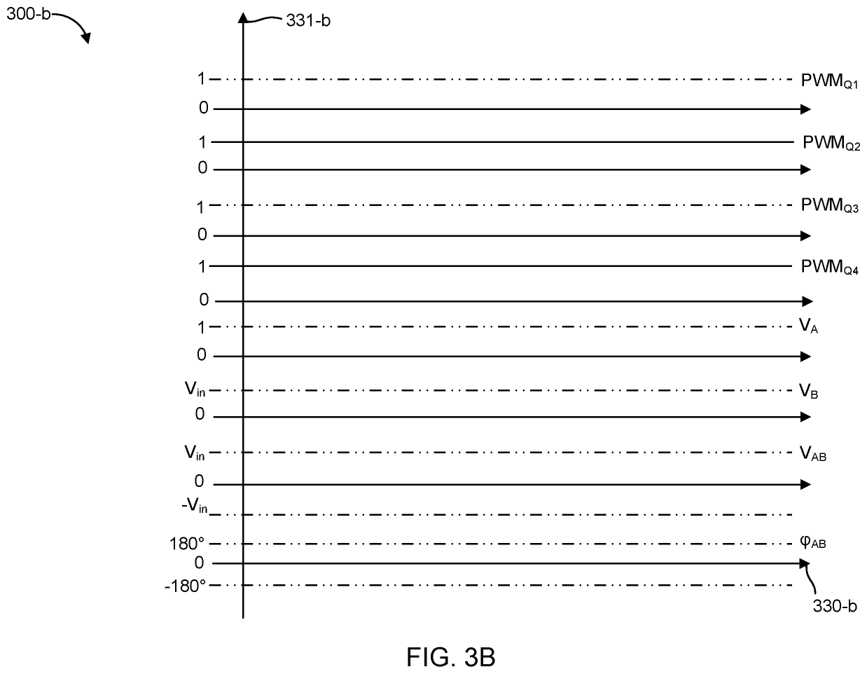

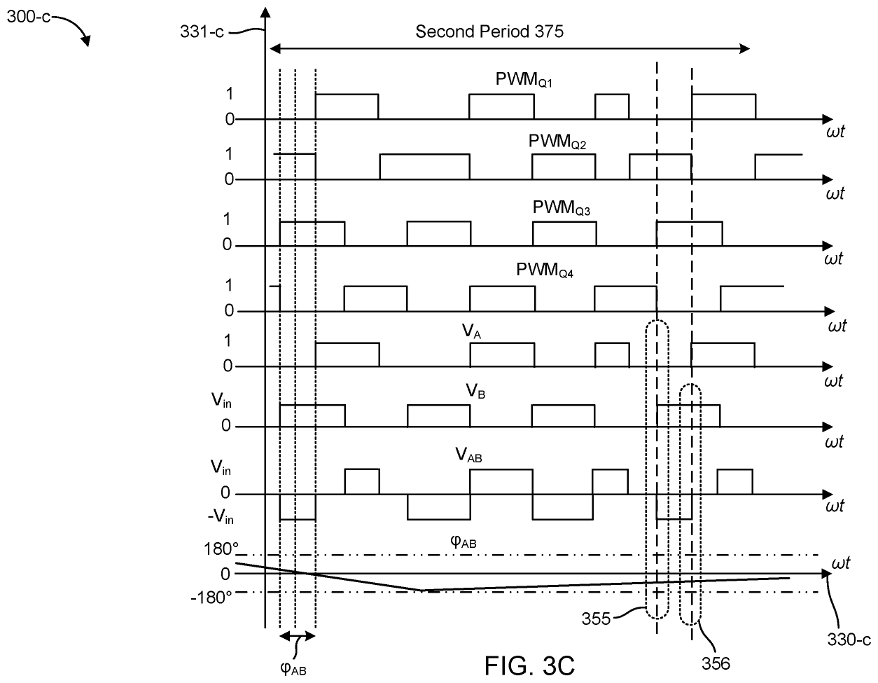

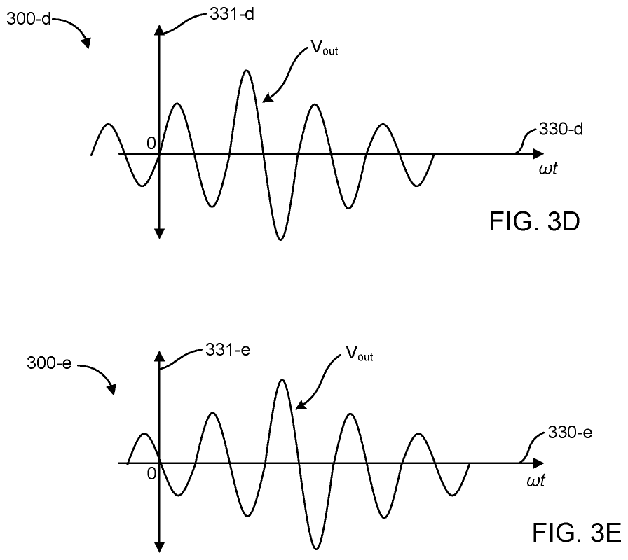

To overcome these challenges, the present disclosure provides a technique for phase shift control that enables altering between which of the two legs of a PSFB converter is the leading leg and which is the lagging leg, which helps ensure that the switching losses are distributed evenly (or substantially evenly) between the switches in the two legs. That is, by alternating which of the first leg (e.g., leg 149-a in FIG. 1B) and the second leg (e.g., leg 149-b) in the leading leg, and thereby experiencing lossy switching transitions (if any), aspects of the present disclosure help distribute the switching losses and prevent a single leg from being burdened with all or most of the switching losses. The timing charts in FIGS. 3A and 3B help illustrate how this solution is implemented to even out heat dissipation in the switching legs.

FIG. 3A illustrates an example of waveforms 300-a for a full-bridge converter (e.g., full-bridge converter 100-b) for a first period, according to various aspects of the disclosure. FIG. 3A depicts the pulse width modulation (PWM) waveforms used to drive each of switches Q₁, Q₂, Q₃, and Q₄ in FIG. 1B. Furthermore, FIG. 3A also depicts the V_{A} and VB waveforms at the terminals 110-a and 110-b, respectively, in FIG. 1B. The waveform V_{AB} corresponding to the voltage between the two terminals 110-a and 110-b is derived from a difference between waveforms V_{A} and V_{B}. Lastly, FIG. 3A also shows the waveform for the phase shift angle (φ_{AB}) between the two terminals 110-a and 110-b in FIG. 1B.

In this example, the left leg (i.e., leg 149-a in FIG. 1B) is the leading leg since V_{A} leads with respect to V_{B}. Specifically, the rising edge and/or falling edges of the V_{A} pulses lead the corresponding rising and/or falling edges of the V_{B} pulses. In some cases, the switches in each leg (e.g., switches Q₁ and Q₂ in leg 149-a, switches Q₃ and Q₄ in leg 149-b) are driven with complementary PWM signals. For example, the signals PWM_{Q1} and PWM_{Q2} are complementary to each other. Similarly, the signals PWM_{Q3} and PWM_{Q4} are complementary to each other. In some embodiments, the set of complementary PWM signals PWM_{Q1} and PWM_{Q2} may be generated from a digital control platform, such as the controller 122 (e.g., controller 122-a and/or controller 122-b). Similarly, the controller 122 (e.g., controller 122-a, controller 122-b) may also be used to generate the set of complementary PWM signals PWM_{Q3} and PWM_{Q4}. As shown in FIG. 1B, the controller 122-b comprising the timing module 112-b directly drives and controls the phase shift of PWM signals driving the switches in one leg of the full-bridge with respect to the PWM signals driving the switches in the other leg. In some cases, a digital counter may be employed to control the phase shift angle (φ_{AB}) between the signal pairs PWM_{Q1}-PWM_{Q3} and/or the signal pairs PWM_{Q2}-PWM_{Q4}. This phase shift dictates the amount of overlap between diagonally opposite switches (e.g., switches Q₁ and Q4, switches Q₂ and Q₃). The longer the overlap between diagonal switches, the larger the output voltage, Vₒᵤₜ. In this way, the controller 122-b regulates the output voltage, Vₒᵤₜ, by way of controlling the phase shift between the PWM signals driving the two legs 149-a, 149-b of the full-bridge converter. FIGS. 3D and 3E illustrate examples of the output voltage (Vₒᵤₜ) waveforms associated with the waveforms shown in FIGS. 3A and 3B, respectively.

During the first period, one or more cycles of PWM_{Q1} are sent to the upper switch (Q₁) of leg 149-a and one or more cycles of PWM_{Q2} are sent to the lower switch (Q₂) of leg 149-b. Additionally, one or more cycles of PWM_{Q3} are sent to the upper switch (Q₃) of leg 149-b and one or more cycles of PWM_{Q4} are sent to the lower switch (Q₄) of leg 149-b. As seen, when the first leg 149-a comprising switches Q₁ and Q₂ is the leading leg, a constant duty cycle (e.g., 50%) is utilized for regulating the switches Q₁ and Q₂. In contrast, in FIG. 3A, the PWM signals (i.e., PWM_{Q3} and PWM_{Q4}) used to drive the switches in the lagging leg 149-b do not utilize a constant duty cycle (or utilize a different duty cycle than the one used to regulate the switches in leg 149-a). In some cases, the amplitude of the output voltage (e.g., shown as Vₒᵤₜ in graphs 300-d and 300-e in FIGS. 3D and 3E, respectively) may be based at least in part on the duty cycle selection for the PWM signals. In some examples, the non-constant duty ratios in the PWMs are a result of changing the phase shift value (φ_{AB}). Whenever one phase shift value is kept constant for over a period of the switching frequency, the duty ratio of all switches (i.e., switches Q₁ through Q₄) may be at or near 50%. As shown in FIGS. 3A and/or 3C, the varying duty ratio of the PWM signals is a by-product of the varying phase shift value. Furthermore, the amplitude of the output waveform (e.g., Vₒᵤₜ in FIG. 3D) may be controlled by the effective duty ratio utilized for the different positive and negative levels of V_{AB}, which in turn can be achieved through modification of the phase shift angle (φ_{AB}). In other words, the amplitude of the output waveform (Vₒᵤₜ) can be controlled by modifying the phase shift angle (φ_{AB}), as modification of the phase shift angle results in a change in the potential difference (V_{AB}) between the voltage at terminal A and the voltage at terminal B. As noted above, the load may be configured to be coupled between the two terminals A and B.

For instance, as seen in FIG. 3A, the switches Q₃ and Q₄ are ON and OFF for different lengths of time, as opposed to the switches Q₁ and Q₂ which are ON and OFF for the same or substantially the same lengths of time.

At transition 345, which is a P-A transition, low voltage switching (LVS) is seen in the left leg 149-a. Furthermore, at transition 346 (i.e., A to P transition), ZVS is seen in lagging leg 149-b. During the first period, there are more losses in the leading leg 149-a, as a result of the positive phase shift angle (φ_{AB}). FIG. 3C described in further detail below depicts the PWM pulses, voltage waveforms (i.e., V_{A}, V_{B}, V_{AB}), and phase shift angle for a second period, where the second period is adjacent the first period. During the second period, the PWM pulses generated by the controller 122 (e.g., controller 122-b in FIG. 1B) enable the right leg 149-b to be the leading leg, which allows the switching losses associated with LVS to be incurred on that leg. In this way, aspects of the present disclosure enable the switching losses to be distributed evenly (or substantially evenly) across the two legs, which helps simplify heat sink design and/or allows for a more compact system, as compared to the prior art.

FIG. 3B illustrates an example of waveforms 300-b for a full-bridge converter, such as full-bridge converter 100-b, according to various aspects of the disclosure. In this example, the phase shift angle (φ_{AB}) is zero, implying no switching and no losses. In some cases, during zero phase shift duration(s), only the bottom switches (e.g., switch Q₂ in leg 149-a, switch Q₄ in leg 149-b) of each leg of the inverter are kept ON, which serves to reduce or minimize power loss during such intervals.

FIG. 3C illustrates an example of waveforms 300-c for a full-bridge converter (e.g., full-bridge converter 100-b in FIG. 3C), according to various aspects of the disclosure. FIG. 3C depicts the PWM waveforms for each of switches Q₁, Q₂, Q₃, and Q₄ in FIG. 1B during operation of the full-bridge converter. Furthermore, FIG. 3C also depicts the VA and V_{B} waveforms at the two terminals 110-a and 110-b, respectively, in FIG. 1B. The waveform V_{AB} corresponding to the voltage between the two terminals 110-a and 110-b is derived from a difference between waveforms V_{A} and V_{B}. Lastly, FIG. 3C also shows the waveform for the phase shift angle (φ_{AB}) between the two terminals 110-a and 110-b in FIG. 1B.

As seen, PWM_{Q3} and PWM_{Q4} are 180 degrees out of phase (i.e., complementary to each other). In this case, PWM_{Q1} and PWM_{Q2} are also 180 degrees out of phase. In some cases, during the second period, one or more cycles of PWM_{Q1} are sent to the upper switch (Q₁) of leg 149-a and one or more cycles of PWM_{Q2} are sent to the lower switch (Q₂) of leg 149-b. Additionally, one or more cycles of PWM_{Q3} are sent to the upper switch (Q₃) of leg 149-b and one or more cycles of PWM_{Q4} are sent to the lower switch (Q₄) of leg 149-b. During the second period, the right leg 149-b is the leading leg, since the rising and falling edges of V_{B} are leading with respect to the rising and falling edges, respectively, of V_{A}. In some cases, less or reduced ZVS (also referred to as LVS) is seen in leg 149-b when it is the leading leg and/or when the phase shift angle is negative. For instance, at switching transition 355 (P-A transition), LVS is seen in the leading leg 149-b comprising switches Q₃ and Q₄. Furthermore, at switching transition 356 (A-P transition), ZVS is seen in the lagging leg 149-a comprising switches Q₁ and Q₂. That is, during the second period, the switching transition(s), such as transition 356, in the left leg 149-a result in minimal or no losses since these transitions are A-P transitions and/or coincide with ZVS conditions. Additionally, the switching transition(s), such as transition 355, in the right leg 149-b may be associated with higher losses than the left leg 149-a switching transitions since these transitions are P-A transitions and/or do not occur under ZVS conditions.

In this way, when the phase shift angle (φ_{AB}) is negative, more losses are incurred in leg 149-b, while minimal to no losses are incurred in leg 149-a. Contrastingly, when the phase shift angle (φ_{AB}) is positive, more losses are incurred in leg 149-a as compared to leg 149-b, as previously described in relation to FIG. 3A.

Similar to FIG. 3A, non-constant duty cycles are utilized for the PWM signals (PWM_{Q1} and PWM_{Q2}) used to drive the switches Q₁ and Q₂ in the lagging leg 149-a. For instance, as seen in FIG. 3C, the switches Q₁ and Q₂ are ON and OFF for different lengths of time, as opposed to the switches Q₃ and Q₄ which are ON and OFF for the same or substantially the same lengths of time (e.g., the duty cycle of PWM_{Q3} and PWM_{Q4} are at or around 50%). In some cases, the amplitude of the output voltage (e.g., shown as Vₒᵤₜ in graphs 300-d and 300-e in FIGS. 3D and 3E, respectively) may be based at least in part on the duty cycle selection for the PWM signals. In some circumstances, the duty ratio of the PWM signals is not selected. Instead, the non-constant duty ratios of the PWM signals used to drive the switches may occur as a consequence of controlling the phase shift angle (φ_{AB}). In some embodiments, the value of the phase shift angle (φ_{AB}) can be selected based on a continuously variable saw-tooth wave (or another applicable wave) or based on a control to output transfer function (e.g., for PSFB DC-DC converters).

FIG. 3D illustrates an example of a voltage output waveform 300-d corresponding to the waveforms shown in FIG. 3A, according to various aspects of the disclosure. In some cases, the amplitude of the output voltage (Vₒᵤₜ) can be controlled by varying the duty ratio of the PWM pulses sent to the switches of the PSFB inverter. In FIG. 3D, the amplitude of the output voltage, Vₒᵤₜ, is shown on the y-axis 331-d and time is shown on the x-axis 330-d.

FIG. 3E illustrates an example of a voltage output waveform 300-e corresponding to the waveforms shown in FIG. 3C, according to various aspects of the disclosure. In FIG. 3E, the amplitude of the output voltage, Vₒᵤₜ, is shown on the y-axis 331-e and time is shown on the x-axis 330-e.

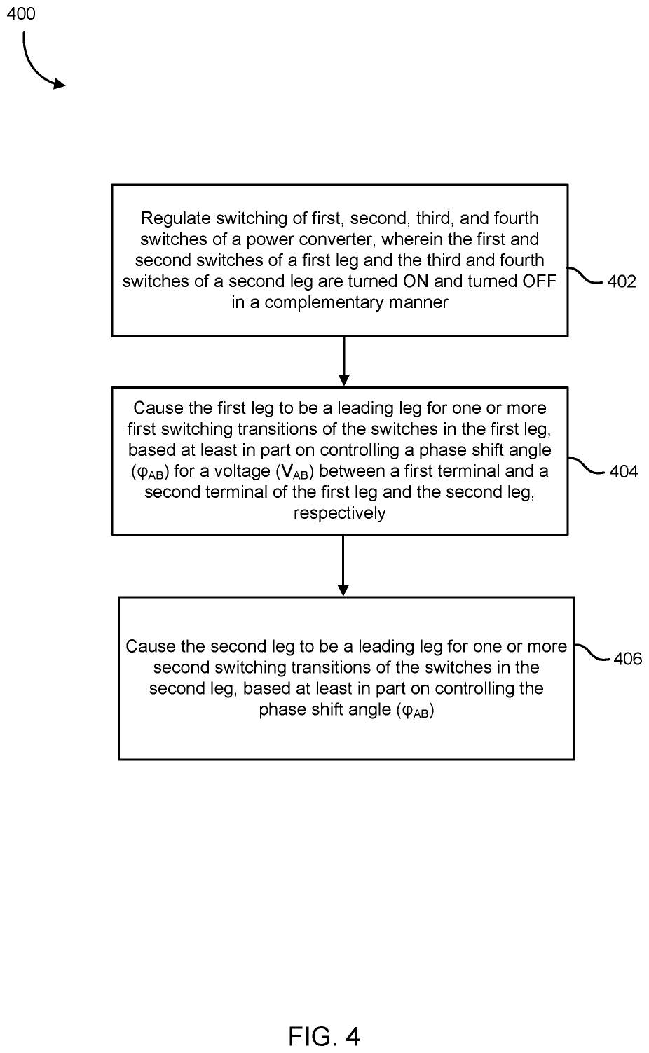

FIG. 4 illustrates an example of a method 400 for phase shift control of a power converter, according to various aspects of the disclosure. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, controller 122-b in FIG. 1B, and/or timing module 112-b in FIG. 1B). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

In some embodiments, the power converter may be similar or substantially similar to the power converter 100-a and/or 100-b described in relation to FIGS. 1A and/or 1B, respectively. The power converter may be configured to couple to a load and may include a first leg and a second leg, each of the first and the second leg comprising a switch pair. In some cases, a first terminal (e.g., terminal 110-a in FIG. 1B) of the load may be connected between a first switch and a second switch of the switch pair of the first leg. Additionally, a second terminal of the load may be connected between a third switch and a fourth switch of the switch pair of the second leg.

In some embodiments, each of the first, second, third, and fourth switch is driven using a PWM signal provided from the controller 122 (or alternatively, the timing module 112), as described above in relation to FIGS. 1A-3C. Additionally, the timing module 112 may control the phase shift angle between the PWM signals sent to the top/upper switches of the two legs and/or the phase shift angle between the PWM signals to the bottom/lower switches of the two legs to help distribute switching losses between the two legs.

A first operation 402 may include regulating switching of the first, second, third, and fourth switches of the power converter. In some cases, the first and second switches of the first leg and the third and fourth switches of the second leg may be turned ON and turned OFF in a complementary manner, as described above in relation to FIGS. 1A-3C.

A second operation 404 may include causing the first leg to be a leading leg for one or more first switching transitions (e.g., switching transition 345 in FIG. 3A) of the switches in the first leg, based at least in part on controlling a phase shift angle between the first terminal and the second terminal, for instance, a phase shift angle for a voltage between the first terminal and the second terminal. In some cases, the phase shift angle (φ_{AB}) between the voltage V_{A} at the first terminal and the voltage V_{B} at the second terminal is equal to or substantially equal to the phase shift angle between PWM_{Q1} and PWM_{Q3} (or alternatively, between PWM_{Q2} and PWM_{Q4}) in FIG. 3A.

A third operation 406 may include causing the second leg to be a leading leg for one or more second switching transitions (e.g., switching transition 355 in FIG. 3C) of the switches in the second leg, based at least in part on controlling the phase shift angle between the first terminal and the second terminal, for instance, the phase shift angle between the voltage V_{A} at the first terminal and the voltage V_{B} at the second terminal. In some cases, the phase shift angle (φ_{AB}) between the first terminal and the second terminal is equal to or substantially equal to the phase shift angle between PWM_{Q1} and PWM_{Q3} (or alternatively, between PWM_{Q2} and PWM_{Q4}) in FIG. 3B.

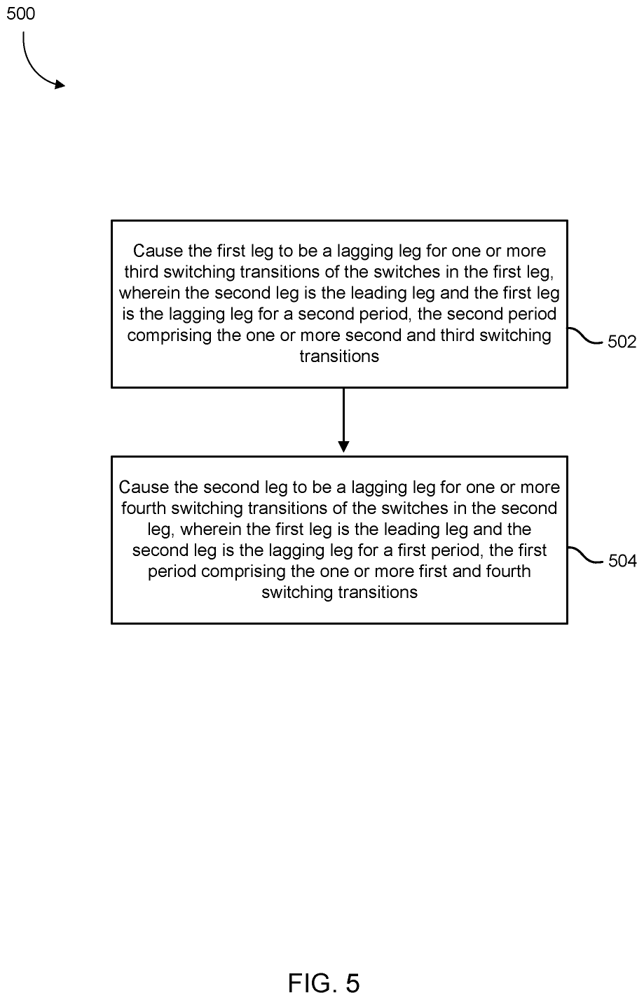

FIG. 5 illustrates an example of a method 500 for phase shift control of a power converter, according to various aspects of the disclosure. The operations of method 500 presented below are intended to be illustrative. In some implementations, method 500 may be accomplished with one or more additional operations not described, and/or without one or more of the operations discussed. Additionally, the order in which the operations of method 500 are illustrated in FIG. 5 and described below is not intended to be limiting.

In some implementations, method 500 may be implemented in one or more processing devices (e.g., a digital processor, an analog processor, a digital circuit designed to process information, an analog circuit designed to process information, controller 122-b in FIG. 1B, and/or timing module 112-b in FIG. 1B). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

A first operation 502 may include causing the first leg to be a lagging leg for one or more third switching transitions (e.g., switching transition 356 in FIG. 3C) of the switches in the first leg. In some cases, the controller 122 (e.g., controller 122-a and/or controller 122-b) controls the phase shift angle between the PWM signals (i.e., PWM_{Q1} and PWM_{Q3}, or PWM_{Q2} and PWM_{Q4}) used to drive the switches, which allows control of the phase shift angle between V_{A} and V_{B}. Furthermore, when the rising edges (or falling edges) of V_{B} lead the rising edges (or falling edges) of V_{A}, the second leg 149-b comprising terminal B is the leading leg and the first leg 149-a comprising terminal A is the lagging leg.

A second operation 504 may include causing the second leg to be a leading leg for one or more fourth switching transitions (e.g., switching transition 355 in FIG. 3C) of the switches in the second leg.

In some embodiments, the first leg is the leading leg and the second leg is the lagging leg for a first period (e.g., first period 365 shown in FIG. 3A), where the first period comprises the one or more first switching transitions (e.g., switching transition 345) and the one or more fourth switching transitions (e.g., switching transition 346). Additionally, the second leg is the leading leg and the first leg is the lagging leg for a second period (e.g., second period 375 shown in FIG. 3C), where the second period comprises the one or more second switching transitions (e.g., switching transition 355) and the one or more third switching transitions (e.g., switching transition 356).

In some cases, the duration of the first period 365 is equal to or substantially equal to the second period 375. Additionally, or alternatively, a digital counter may be utilized to keep track of the number of PWM cycles used during the first period 365 and the second period 375 to help ensure they are equal or approximately equal, which helps ensure that the switching losses are distributed evenly between the switches in the two legs of the power converter (e.g., PSFB inverter). That is, by alternating which of the first leg (e.g., leg 149-a in FIG. 1B) and the second leg (e.g., leg 149-b) is the leading leg, and thereby experiencing lossy switching transitions (if any), aspects of the present disclosure help distribute the switching losses and prevent a single leg from being burdened with all or most of the switching losses.

Thus, the present disclosure not only helps provide a thermally efficient phase-shift control scheme for PSFB converters/inverters, but also helps reduce the form factor, complexity, and/or cost of the power converter, as compared to the prior art.

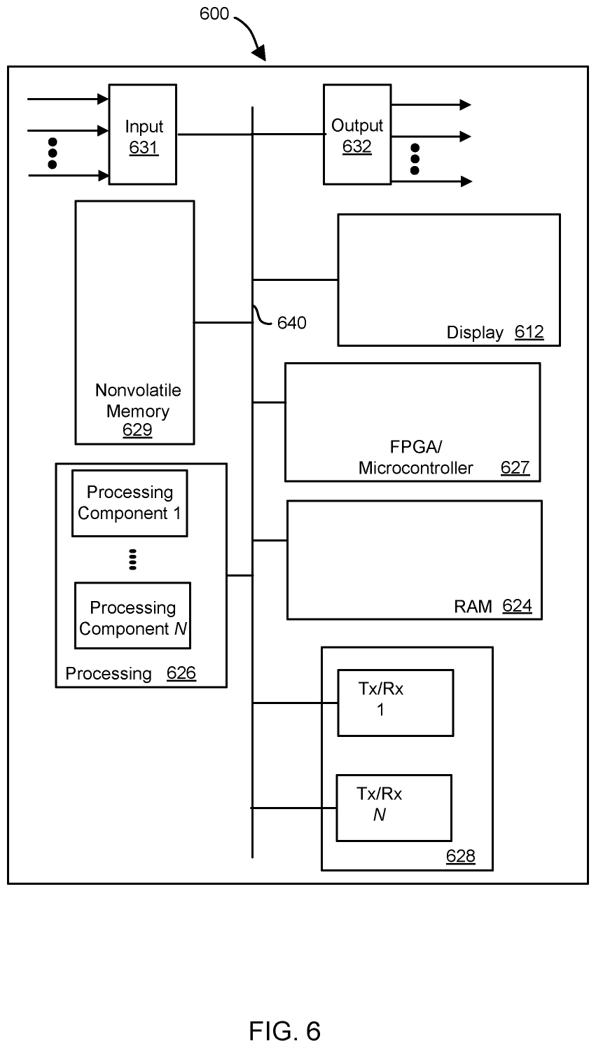

The methods described in connection with the embodiments disclosed herein may be embodied directly in hardware, in processor-executable code encoded in a non-transitory tangible processor readable storage medium, or in a combination of the two. Referring to FIG. 6 for example, shown is a block diagram 600 depicting physical components that may be utilized to realize the timing module 112 (and the controller 122 generally, such as, but not limited to controller 122-b in FIG. 1B) according to an exemplary embodiment. As shown, in this embodiment a display portion 612 and nonvolatile memory 620 are coupled to a bus 640 that is also coupled to random access memory (“RAM”) 624, a processing portion (which includes N processing components) 626, an optional field programmable gate array (FPGA) 627, and a transceiver component 628 that includes N transceivers. Although the components depicted in FIG. 6 represent physical components, FIG. 6 is not intended to be a detailed hardware diagram; thus, many of the components depicted in FIG. 6 may be realized by common constructs or distributed among additional physical components. Moreover, it is contemplated that other existing and yet-to-be developed physical components and architectures may be utilized to implement the functional components described with reference to FIG. 6.

This display portion 612 generally operates to provide a user interface for a user, and in several implementations, the display is realized by a touchscreen display. In general, the nonvolatile memory 620 is non-transitory memory that functions to store (e.g., persistently store) data and processor-executable code (including executable code that is associated with effectuating the methods described herein). In some embodiments for example, the nonvolatile memory 620 includes bootloader code, operating system code, file system code, and non-transitory processor-executable code to facilitate the execution of a method described with reference to FIGS. 4 and/or 5 described further herein.

In many implementations, the nonvolatile memory 620 is realized by flash memory (e.g., NAND or ONENAND memory), but it is contemplated that other memory types may be utilized as well. Although it may be possible to execute the code from the nonvolatile memory 620, the executable code in the nonvolatile memory is typically loaded into RAM 624 and executed by one or more of the N processing components in the processing portion 626.

The N processing components in connection with RAM 624 generally operate to execute the instructions stored in nonvolatile memory 620 to enable phase shift control of full-bridge converters or inverters to assist in thermal management, distribute switching losses across the two legs of the converter, or a combination thereof. For example, non-transitory, processor-executable code to effectuate the methods described with reference to FIGS. 4 and/or 5 may be persistently stored in nonvolatile memory 620 and executed by the N processing components in connection with RAM 624. As one of ordinarily skill in the art will appreciate, the processing portion 626 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 626 may be configured to effectuate one or more aspects of the methodologies described herein (e.g., the method(s) 400 and/or 500 described with reference to FIGS. 4 and/or 5, respectively). For example, non-transitory processor-readable instructions may be stored in the nonvolatile memory 620 or in RAM 624 and when executed on the processing portion 626, cause the processing portion 626 to perform phase shift control of a full-bridge converter. Alternatively, non-transitory FPGA-configuration-instructions may be persistently stored in nonvolatile memory 620 and accessed by the processing portion 626 (e.g., during boot up) to configure the hardware-configurable portions of the processing portion 626 to effectuate the functions of the controller 122 (e.g., controller 122-a, controller 122-b) and/or the timing module 112 (e.g., timing module 112-a, timing module 112-b). As previously noted, the output of a converter, such as a PSFB inverter, may be controlled by controlling the phase shift (φ_{AB}) between the terminals of each leg. A PSFB inverter (e.g., PSFB inverter 100-b in FIG. 1B) may comprise two legs, each leg comprising series arranged switches (e.g., MOSFETs). In some cases, phase shift control comprises controlling the phase shift between the terminal (i.e., connection point between series arranged switches) of one leg with respect to the terminal of the other leg.

The input component 630 operates to receive signals (e.g., a duty ratio for generating the PWM signals used to drive the switches, a phase shift angle φ_{AB} between the PWM signals PWM_{Q1} and PWM_{Q3}, a phase shift angle between the PWM signals PWM_{Q2} and PWMQ4, etc.) that are indicative of one or more aspects of the phase shift control scheme. The signals received at the input component may include, for example, a duty ratio of the PWM signals used to drive the switches in each leg (e.g., when a particular leg is the leading leg, when a particular leg is the lagging leg), a duration or period for which the respective PWM signals are applied to each of the switches, a desired or target voltage output waveform, a reference waveform (e.g., current, voltage waveform), a duration of the first period 365 in FIG. 3A and/or a duration of the second period 375 in FIG. 3C, or any other applicable input signal. The output component generally operates to provide one or more analog or digital signals to effectuate an operational aspect of the controller 122 (e.g., controller(s) 122-a and/or 122-b) and/or timing module 112 (e.g., timing module(s) 112-a and/or 112-b). For example, the output portion 632 may provide the PWM signals for driving the switches of the full-bridge, as described with reference to FIGS. 1-3D.

The depicted transceiver component 628 includes N transceiver chains, which may be used for communicating with external devices via wireless or wireline networks. Each of the N transceiver chains may represent a transceiver associated with a particular communication scheme (e.g., Wi-Fi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A power converter configured to couple to a load, the power converter comprising:
a first leg comprising a first switch and a second switch, the first and second switches configured to be connected to a first terminal of the load, a second leg comprising a third switch and a fourth switch, the third and fourth switches configured to be connected to a second terminal of the load; and
a controller configured to:
regulate switching of the first, second, third, and fourth switches, wherein the switches of each of the first leg and the second leg are switched in a complementary manner;
cause the first leg to be a leading leg for one or more first switching transitions of the switches in the first leg, based at least in part on controlling a phase shift angle between the first terminal and the second terminal; and
cause the second leg to be a leading leg for one or more second switching transitions of the switches in the second leg, based at least in part on controlling the phase shift angle.

2. The power converter of claim 1, wherein the controller is further configured to:
cause the first leg to be a lagging leg for one or more third switching transitions of the switches in the first leg; and
cause the second leg to be the lagging leg for one or more fourth switching transitions of the switches in the second leg.

3. The power converter of claim 2, wherein:
the first leg is the leading leg and the second leg is the lagging leg for a first period, the first period comprising the one or more first switching transitions and the one or more fourth switching transitions;
the second leg is the leading leg and the first leg is the lagging leg for a second period, the second period comprising the one or more second switching transitions and the one or more third switching transitions;
a duration of the first period is substantially equal to the second period.

4. The power converter of claim 3, wherein:
the phase shift angle is at or above 0 degrees during the first period; and
the phase shift angle is below 0 degrees during the second period.

5. The power converter of claim 3, wherein:
a first voltage at the first terminal leads a second voltage at the second terminal when the first leg is the leading leg, and
the second voltage leads the first voltage when the second leg is the leading leg.

6. The power converter of claim 5, wherein a voltage between the first terminal and the second terminal is out of phase by 180 degrees during the first period as compared to the second period.

7. The power converter of claim 3, wherein switching losses associated with the leading leg are substantially evenly distributed between the first leg and the second leg, and wherein the leading leg comprises one of the first leg and the second leg.

8. The power converter of claim 3, wherein, when the first leg is the leading leg,
the first switch and the second switch are regulated using first and second PWM signals, respectively, and wherein the first and second PWM signals have a constant or substantially constant duty ratio; and
the third switch and the fourth switch are regulated using third and fourth PWM signals, respectively, and wherein the third and fourth PWM signals have a variable duty ratio.

9. The power converter of claim 8, wherein the phase shift angle and a voltage between the first terminal and the second terminal are based at least in part on the first, second, third, and fourth PWM signals.

10. The power converter of claim 3, wherein, when the second leg is the leading leg and the first leg is the lagging leg,
the first switch and the second switch are regulated using first and second PWM signals, respectively, and wherein the first and second PWM signals have a variable duty ratio; and
the third switch and the fourth switch are regulated using third and fourth PWM signals, respectively, and wherein the third and fourth PWM signals have a substantially constant duty ratio.

11. The power converter of claim 10, wherein the phase shift angle and a voltage between the first terminal and the second terminal are based at least in part on the first, second, third, and fourth PWM signals.

12. The power converter of claim 2, wherein each of the one or more first, second, third, and fourth switching transitions comprises one of:
a passive to active transition when, prior to a corresponding one of the first, second, third, or fourth switching transitions, a voltage between the first terminal and the second terminal is at or near zero volts, or
an active to passive transition when, prior to a corresponding one of the first, second, third, or fourth switching transitions, an initial voltage is non-zero volts.

13. The power converter of claim 12, wherein:
zero voltage switching (ZVS) is achieved in a corresponding leg during active to passive transitions; and
non-zero voltage switching or low voltage switching is achieved in a corresponding leg during passive to active transitions and when the phase shift angle is at or below a threshold.

14. The power converter of claim 1, wherein the power converter comprises a phase-shift full-bridge (PSFB) inverter.

15. A method for phase shift control, the method comprising:
providing a full bridge power converter, wherein the full bridge power converter is configured to couple to a load and comprises,
a first leg comprising a first switch and a second switch, the first and second switches configured to be connected to a first terminal of the load, and
a second leg comprising a third switch and a fourth switch, the third and fourth switches configured to be connected to a second terminal of the load; and
regulating switching of the first, second, third, and fourth switches, wherein the switches of each of the first leg are switched in a complementary manner; and
controlling a phase shift angle between the first terminal and the second terminal such that,
the first leg is a leading leg for one or more first switching transitions of the switches in the first leg, and
the second leg is a leading leg for one or more second switching transitions of the switches in the second leg.

16. The method of claim 15, further comprising:
causing the first leg to be a lagging leg for one or more third switching transitions of the switches in the first leg; and
causing the second leg to be the lagging leg for one or more fourth switching transitions of the switches in the second leg.

17. The method of claim 16, wherein:
the first leg is the leading leg and the second leg is the lagging leg for a first period, the first period comprising the one or more first switching transitions and the one or more fourth switching transitions;
the second leg is the leading leg and the first leg is lagging leg for a second period, the second period comprising the one or more second switching transitions and the one or more third switching transitions; and
a duration of the first period is substantially equal to the second period.

18. The method of claim 17, wherein:
the phase shift angle is at or above 0 degrees during the first period;
the phase shift angle is below 0 degrees during the second period; and
the phase shift angle is based at least in part on at least one switch of the first leg turning ON or OFF at a different time than at least one switch of the second leg.

19. The method of claim 17, wherein switching losses associated with the leading leg are substantially evenly distributed between the first leg and the second leg, and wherein the leading leg comprises one of the first leg and the second leg.

20. A non-transitory, tangible computer readable storage medium, encoded with processor readable instructions to perform a method for phase shift control of a power converter, wherein the power converter is configured to couple to a load and comprises a first leg and a second leg, the method further comprising:
connecting a first terminal of the load between a first switch and a second switch of the first leg;
connecting a second terminal of the load between a third switch and a fourth switch of the second leg;
regulating switching of the first, second, third, and fourth switches of the power converter, wherein the switches of the first leg and the second leg are switched in a complementary manner; and
controlling a phase shift angle between the first terminal and the second terminal such that,
the first leg is a leading leg for one or more first switching transitions of the switches in the first leg, and
the second leg is a leading leg for one or more second switching transitions of the switches in the second leg.
